(19) United States
(12) Patent Application Publication
(10) Pub. No.: US 2005/0182176 A1
(43) Pub. Date: Aug. 18, 2005

(54) Bonding inorganic moldings produced from powder injection molding materials by injection molding to inorganic moldings produced by a method other than injection molding

(75) Inventors: Hans Wohlfromm, Mannheim (DE); Arnd Thom, Alzey (DE); Johan Herman Hendrik ter Maat, Mannheim (DE); Martin Blomacher, Meckenheim (DE)

Correspondence Address: CONNOLLY BOVE LODGE & HUTZ LLP, SUITE 800, 1990 M STREET NW, WASHINGTON, DC, 20036-3425, US

(73) Assignee: BASF Aktiengesellschaft

(21) Appl. No.: 11/054,939

(22) Filed: Feb. 11, 2005

(30) Foreign Application Priority Data
Feb. 12, 2004 (DE) 10 2004 006 954.9

(51) Int. Cl. C08K 3/08

(52) U.S. Cl. 524/439

(57) ABSTRACT

At least one first inorganic molding (1) produced from a powder injection molding material by injection molding is permanently bonded to at least one second inorganic molding (2) produced by a method other than injection molding by a method comprising the method steps:
a) injection molding the first inorganic molding (1) from binder-containing powder injection molding materials,
b) removing binder from the first inorganic molding (1) and
c) carrying out a sinter process with the first and second inorganic moldings (1, 2) fitted together,
   the at least one first inorganic molding (1) and the at least one second inorganic molding (2) being fitted together before step b) or before step c).

The present invention relates to a method for bonding at least one first inorganic molding produced from powder injection molding materials by injection molding to at least one second inorganic molding produced by a method other than injection molding, and the use of this method.

It is known that moldings can be produced from inorganic materials by mixing metal powder or ceramic powder with binders to give an injection-moldable powder injection molding material, processing this powder injection molding material on injection molding machines to give moldings (green compacts), removing the binders from these moldings (brown compacts) and then sintering the moldings. Such a method is described, for example, in DE 40 00 278 A1. This German Laid-Open Application relates to a method for the production of an inorganic sintered shaped article by molding a mixture of a sinterable inorganic powder and polyoxymethylene as binder by injection molding or extrusion to give a green compact, removing the binder and sintering. The polyoxymethylene is removed by treating the green compact in an atmosphere containing gaseous boron trifluoride.

Compared with other production methods, the moldings produced by the known method have, inter alia, the advantages that a wide range of materials are available for this purpose, that complex geometries can be produced and that narrow tolerances can be achieved without reworking (accuracy about ±0.3%) and good surfaces can be obtained.

In the prior art, such organic moldings produced from powder injection molding materials are bonded to other moldings produced by means of other production methods, inter alia by welding, screwing, adhesive bonding or forging, depending on the material. These joining methods are, however, not equally suitable for all material combinations, and high costs are frequently incurred when permanently joining individual moldings and the bonds produced thereby between two moldings do not always meet the requirements set for them. Thus, the known joining methods are problematic, particularly when bonding high-alloy and low-alloy steels, since chemical corrosion frequently occurs here. Furthermore, for example, hardened tool steels and superalloys, such as Hastelloy® from Haynes, Kokomo, USA, can be mechanically processed only with high technical complexity.

It is an object of the present invention to provide an improved method for permanently bonding inorganic moldings produced from powder injection molding materials by injection molding to inorganic moldings produced by methods other than injection molding. In particular, it is intended to permit intimate bonding of these moldings with reduction of the production costs, which bonding can be carried out by an uncomplicated method. Furthermore, it is an object of the present invention to permit the joining of these moldings to form a unit which withstands high mechanical loads.

We have found that this object is achieved, according to the invention, by a method for permanently bonding at least one first inorganic molding (1) produced from powder injection molding materials by injection molding to at least one second inorganic molding (2) produced by a method other than injection molding, comprising the method steps:
a) injection molding the first inorganic molding (1) from binder-containing powder injection molding materials,
b) removing binder from the first inorganic molding (1) and
c) carrying out a sinter process with the first and second inorganic moldings (1, 2) which have been fitted together,
   the at least one first inorganic molding (1) and the at least one second inorganic molding (2) being fitted together before step b) or before step c).

In step a), a first inorganic molding is first produced from powder injection molding materials by injection molding. The first inorganic molding may be a metal body. The powder injection molding materials are present, for example, as injection-moldable granules which contain both an inorganic powder (for example metal powder) and a binder. Preferably, a product from the Catamold® product range of BASF AG, Ludwigshafen, Germany, is used as the injection molding material. Such injection molding materials are disclosed, for example, in DE 197 00277 A1 or DE 4021 739 A1. For injection molding of the first inorganic molding, standard machines for injection molding of thermoplastics can be used. If appropriate, the injection molding machine must be adapted to the material properties of the powder injection molding material of the first inorganic molding, for example by means of special screw geometries or dies, by incorporation of a back-flow block or by increasing the protection against wear.

In step b) of the novel process, binder is removed from the first inorganic molding. Removal of binder is understood as meaning the substantial removal of the binder from the first inorganic molding (green compact) produced by injection molding. The binder removal process depends on the binder contained in the powder injection molding material.

In the prior art, there are binder systems comprising thermally decomposable binders, in particular waxes. These are removed from the first inorganic molding by a thermal binder removal process (melting out or decomposition via the gas phase). Another possibility for binder removal is solvent extraction, in which the binder is removed with solvents, such as water or acetone.

The most widely used process is catalytic binder removal, which permits short binder removal times. For example, the Catamold® powder injection molding materials of BASF AG contain polyacetal as a binder. In the presence of a suitable catalyst, polyacetal can be depolymerized even in the nonmolten state to give gaseous components and consequently removed without residue from the injection molded part. This is permitted by the particular chemical structure of the polyacetal. In contrast to polyethylene, polyacetal is characterized by repeating carbon-oxygen bonds. Acids can attack at the oxygen atom of this group and cleave the macromolecule into the basic building blocks CH₂O (formaldehyde). A preferably used catalyst is gaseous nitric acid (>99%). The particular suitability of this chemical reaction for removing binder in powder injection molding is to be seen in the conditions under which it takes place. The polymer has a melting point of about 165° C. The binder removal takes place at substantially below the melting point, at from 110 to 140° C. The reaction progresses in the form of a front from the outside inward through the part from which binder is to be removed. During the reaction, the polymer is converted directly from the solid into the gaseous state. The reaction gas can thus escape very easily through the already porous zones of the molding. A pressure buildup and the resulting destruction of the molding can thus be avoided. The monomer forming has a boiling point of −21° C. and is thus in any case gaseous under conditions of binder removal. In principle, 100% binder removal could be achieved in this manner. Such moldings would, however, decompose under the slightest vibration. A small proportion of the binder therefore consists of a polymer which is resistant to the catalyst and imparts to the molding sufficient strength for the further processing. This proportion is expelled during the subsequent sinter process. The first inorganic molding from which binder has been removed is referred to as a brown compact.

In step c) of the novel method, a sinter process is carried out with the assembled first and second inorganic moldings.

The second inorganic molding is an inorganic molding produced by a method other than injection molding, for example a shaped article produced by compression sintering, casting, forging, milling or turning.

Sintering is to be understood as meaning a heat treatment process in which the loose powder framework of the first inorganic molding from which binder has been removed (brown compact) is compacted to give the finished component and at the same time is bonded to the second inorganic molding. Thermally activated material transport, which leads to a reduction in the specific surface area of the inorganic powder particles, takes place during the sintering. As a result of the growth of particle contacts and the reduction in the pore volume, the first inorganic molding shrinks during the sintering in step c) of the novel method. Furthermore, particle contacts between the particles of the first inorganic molding and of the second inorganic molding form as a result of the sinter process at contact surfaces of the molding assembled before the sinter process is carried out. An intimate bond forms between the two moldings.

The novel method consequently permits economical bonding of inorganic injection moldings to inorganic non-injection moldings in large quantities.

In the present invention, the first inorganic molding and the second inorganic molding can be assembled before step b) of the novel method or before step c) of the novel method. If the moldings are assembled before step b), they pass through the binder removal step b) together. The novel method steps b) and c) are carried out in two different furnaces (binder removal furnace and sinter furnace) or in succession in a single furnace. The assembly of the moldings before step b) has the advantage that the brittle brown compact (the first molding from which binder has been removed) need no longer be moved singly before the sinter process is carried out, and thus possible fragmentation of the brown compact is avoided. Careful assembly of the moldings after removal of the binder from the first inorganic molding and before the common sinter process is carried out is, however, also possible.

In a preferred embodiment of the present invention, the powder injection molding material for injection molding of the first inorganic molding contains
i) from 40 to 85% by volume of at least one inorganic sinterable powder A,
ii) from 15 to 60% by volume of at least one binder B and
iii) from 0 to 5% by volume of at least one dispersant C, the sum of the components A, B and C being 100% by volume.

The inorganic sinterable powder A can be selected from all known suitable inorganic sinterable powders. It is preferably selected from metal powders, metal alloy powders, metal carbonyl powders and mixtures thereof.

Examples of metals which may be present in powder form are iron, cobalt, nickel and silicon. Alloys are, for example, light metal alloys based on aluminum and titanium, and alloys of copper or bronze. Hard metals, such as tungsten carbide, boron carbide or titanium nitride, are also suitable, in combination with metals such as cobalt and nickel. Suitable powders are described, for example, in EP-A 0 465 940, EP-A 0 710 516, DE-A 39 36 869, DE-A 40 00 278 and EP-A 0 114 746 and the literature cited therein.

The particle sizes of the powders are preferably from 0.1 to 50 μm, particularly preferably from 0.2 to 8 μm. The metal powders, metal alloy powders and metal carbonyl powders can also be used as a mixture.

The dispersant optionally present as component C may be selected from known dispersants. Examples are oligomeric polyethylene oxide having an average molecular weight of from 200 to 600, stearic acid, stearamide, hydroxystearic acid, fatty alcohols, fatty alcohol sulfonates and block copolymers of ethylene oxide and propylene oxide, as well as, particularly preferably, polyisobutylene. Particularly preferably, polyisobutylene is used in an amount of from 1 to 6% by volume, based on the components A, B and C.

In addition, the thermoplastic materials may also contain conventional additives and processing assistants which advantageously influence the rheological properties of the mixtures during the molding.

Preferably, the at least one second inorganic molding contains at least one material from the group consisting of low-alloy steels, stainless steels, tool steel, soft magnetic alloys, light metals, heavy metals, copper-based materials or noble metals.

In a preferred embodiment of the present invention, the sinter process which is carried out in a furnace comprises the following steps:
A) heating the furnace containing the assembled first and second inorganic moldings from room temperature to a first hold temperature of from 300 to 700° C., preferably from 550 to 650° C., at a rate of from 2 to 10, preferably from 4 to 6, K/min,
B) maintaining the first hold temperature, preferably for a period of from 0.5 to 3 hours,
C) heating the furnace to a second hold temperature of from 1000 to 1400° C., preferably from 1200 to 1300° C., at a rate of from 2 to 10, preferably from 4 to 6, K/min,
D) maintaining the second hold temperature, preferably for a period of from 2 to 12 hours, and
E) cooling the furnace at a rate of from 2 to 20 K/min.

This sinter process is particularly suitable for powder injection molding materials from the Catamold® product range of BASF AG. In general, the sinter process must be tailored to the respective material to be sintered. In the above-mentioned temperature program, the fact that a small proportion of residual binder is still present in the first inorganic molding after the binder removal in step b) is taken into account. By maintaining the first hold temperature in step b), complete thermal decomposition of this residual binder takes place. The maximum sinter temperature to be reached (second hold temperature in step C)) depends on the material of the first and the second inorganic molding.

The sinter process preferably takes place in inert gas or under reduced pressure. The inert gas atmosphere or the reduced pressure are necessary in order to prevent undesired chemical reactions during the sintering. When choosing the atmosphere, all reactions possible between the gas, the sinter material and the furnace should be taken into account. Possible inert gases are hydrogen, argon or nitrogen or a mixture thereof.

In a preferred embodiment of the present invention, a lubricant is applied to at least parts of the contact surfaces of the assembled first and second inorganic moldings before step c). The lubricant serves for ensuring the shrinkage of the first inorganic molding during the sinter process without hindrance and without an intimate bond between the shaped articles, which is undesired in certain areas. The lubricant is therefore applied before the sinter step to those surface sections of the shaped articles which are in contact after their assembly but which are not to be bonded by the sintering, but rather along which surface sections the first inorganic molding slides as a result of the shrinkage during sintering. A necessary property of the lubricant is therefore its sliding action at the maximum sintering temperature (second hold temperature). Preferred lubricants for the novel method are boron nitride, molybdenum sulfide or molybdenum disulfide.

In a preferred embodiment of the present invention, a polymer film is inserted, before the sinter process is carried out, between certain surfaces to be sintered together. The polymer film may perform various functions. It may ensure a better bond between the first inorganic molding and the second inorganic molding since it has a lower melting point than the maximum sintering temperature and consequently displays an adhesive effect between the moldings during the sinter process. Furthermore, it may release carbon, which diffuses into the surfaces of both moldings, reduces the melting point there and thus permits sintering closer to the melting point. The polymer film may be selected from all known suitable polymer films. It preferably contains a polymer from the group consisting of polyethylene (PE), polypropylene (PP) or polyvinyl chloride (PVC).

The present invention furthermore relates to the use of the novel method for the production of gear parts, gear wheels, jewelry, levers, nozzles, covers, pump parts, electric motor parts, ball bearings, valves, weapons parts, sports apparatuses, household appliances, medical equipment, tools or parts thereof. The use of the novel method is, however, not limited to the production of said workpieces.

### DRAWING

The invention is explained in more detail below with reference to the drawing.

FIG. 1 schematically shows the sequence of the novel method in its preferred embodiment.

FIG. 1 shows, in illustration i, a section through two moldings which are to be firmly bonded to one another with the aid of the novel method.

The first inorganic molding 1 is an annular workpiece which is present as a green compact in illustration i, i.e. was produced by means of injection molding from a powder injection molding material, or which is present as a brown compact, i.e. has already had the binder removed from it. The powder injection molding material comprised, for example, injection-moldable granules for the production of sintered shaped articles from a low-alloy, case-hardenable steel of the type 8620.

The second inorganic shaped article is, for example, a forged part of high-alloy steel. It has a cylindrical second 3 whose radius is smaller than the radius of the first inorganic shaped article 1.

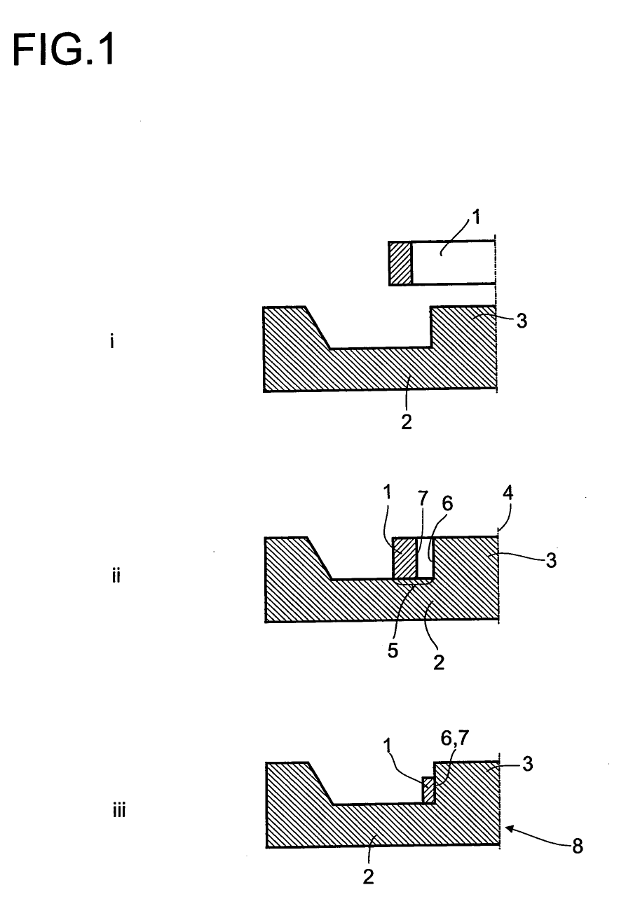

In illustration ii of FIG. 1, the two moldings 1 and 2 have been assembled. The annular first molding 1 surrounds the cylindrical section 3 of the second molding 2, the symmetry lines 4 of the two moldings 1, 2 coinciding. If the first molding 1 is a green compact which still contains binder, the binder removal is carried out according to the novel method in the assembled state of the two moldings 1, 2 according to illustration ii of FIG. 1 before the sinter process begins.

If the first molding 1 is a brown compact from which binder has been removed, the sinter process can be carried out as the next step after assembly of the two moldings 1, 2.

A lubricant (not shown) is preferably applied to those contact surfaces 5 of both shaped articles on which the first molding 1 slides during its shrinkage owing to the sintering.

A polymer film (not shown) is preferably placed on a surface 6 of the second molding before the sintering and is consequently present between those surfaces 6 and 7 of the two moldings 2 and 1, respectively, which are to be joined by sintering.

Illustration iii of FIG. 1 shows the moldings 1, 2 bonded according to the novel method after the sinter process has been carried out. Molding 1 has been shrunk during sintering on the cylindrical section 3 of the second molding 2 and has been sintered together with this on the surfaces 6, 7. The workpiece 8 produced in this manner is, for example, a gear part.

### LIST OF REFERENCE NUMERALS

1 First inorganic molding
2 Second inorganic molding
3 Cylindrical section
4 Symmetry lines
5 Contact surfaces
6 Surface of the second molding which is to be joined by sintering
7 Surface of the first molding which is to be joined by sintering
8 Workpiece

1. A method for permanently bonding at least one first inorganic molding produced from powder injection molding materials by injection molding to at least one second inorganic molding produced by a method other than injection molding, comprising the method steps:
a) injection molding the first inorganic molding from binder-containing powder injection molding materials,
b) removing binder from the first inorganic molding and
c) carrying out a sinter process with the first and second inorganic moldings which have been fitted together,
the at least one first inorganic molding and the at least one second inorganic molding being fitted together before step b) or before step c).

2. A method according to claim 1, wherein the powder injection molding material for injection molding of the first inorganic molding contains
i) from 40 to 85% by volume of at least one inorganic sinterable powder A),
ii) from 15 to 60% by volume of at least one binder B and
iii) from 0 to 5% by volume of at least one dispersant C,
the sum of the components A, B and C being 100% by volume.

3. A method according to claim 2, wherein the powder A is selected from metal powders, metal alloy powders, metal carbonyl powders and mixtures thereof.

4. A method according to claim 1, wherein the at least one second inorganic molding contains at least one material from the group consisting of low-alloy steel, stainless steels, tool steel, magnetically soft alloys, light metals, heavy metals, copper-based materials or noble metals.

5. A method according to claim 1, wherein the sinter process is carried out in a furnace and comprises the following steps:
A) heating the furnace containing the assembled first and second inorganic moldings from room temperature to a first hold temperature of from 300 to 700° C. at a rate of from 2 to 10 K/min,
B) maintaining the first hold temperature,
C) heating the furnace to a second hold temperature of from 1000 to 1400° C. at a rate of from 2 to 10 K/min,
D) maintaining the second hold temperature and
E) cooling the furnace at a rate of from 2 to 20 K/min.

6. A method according to claim 1, wherein a lubricant is applied to at least parts of the contact surfaces of the assembled first and second inorganic moldings before the sinter process is carried out.

7. A method according to claim 6, wherein the lubricant is boron nitride, molybdenum sulfide or molydenum disulfide.

8. A method according to claim 1, wherein a polymer film is inserted, before the sinter process is carried out, between certain surfaces to be sintered together.

9. A method according to claim 8, wherein the polymer film contains a polymer from the group consisting of polyethylene, polypropylene or polyvinyl chloride.

10. The method according to claim 1 used for producing gear parts, gear wheels, jewelry, levers, nozzles, covers, pump parts, electric motor parts, ball bearings, valves, weapons parts, sports apparatuses, household appliances, medical equipment, tools or parts thereof.
